(19) United States
(12) Patent Application Publication
(10) Pub. No.: US 2022/0330255 A1
(43) Pub. Date: Oct. 13, 2022

(54) COMMUNICATION SYSTEM, WIRELESS TERMINAL, AND WIRELESS COMMUNICATION METHOD

(71) Applicant: LAPIS Technology Co., Ltd., Yokohama (JP)

(72) Inventors: Miwa HAYASHI, Yokohama (JP); Susumu FUJIMOTO, Yokohama (JP)

(73) Assignee: LAPIS Technology Co., Ltd., Yokohama (JP)

(21) Appl. No.: 17/713,860

(22) Filed: Apr. 5, 2022

(30) Foreign Application Priority Data
Apr. 9, 2021 (JP) 2021-66664

(51) Int. Cl. H04W 72/08; H04W 40/22; H04W 52/02

(52) U.S. Cl. CPC H04W 72/08; H04W 40/22; H04W 52/0241

(57) ABSTRACT

The present invention includes a plurality of wireless terminals that each transmit a data packet including an acquired information signal by a first wireless communication scheme, and a relay device that receives the data packet transmitted from the wireless terminal and transmits the received data packet by a second wireless communication scheme. Each of the wireless terminals includes a first wireless communication circuit that performs a wireless communication by the first wireless communication scheme, a second wireless communication circuit that performs a wireless communication by the second wireless communication scheme, and a control unit that determines whether a wireless channel of the second wireless communication scheme is in use or not, and causes the first wireless communication circuit to transmit the data packet including the information signal to the relay device when the wireless channel is determined to be unused.

### CROSS-REFERENCE TO RELATED APPLICATION

This application is based upon and claims the benefit of priority from the prior Japanese Patent Application No. 2021-66664 filed on Apr. 9, 2021, the entire contents of which are incorporated herein by reference.

### BACKGROUND

### 1. Technical Field

The present invention relates to a communication system, especially, a communication system including a plurality of wireless terminals and relay devices, a wireless terminal, and a wireless communication method.

### 2. Description of the Related Art

Recently, a wireless communication system in which Internet of Things (IoT) is combined with a wireless public network, such as Sigfox, to perform a service of providing specific information to a user has been attracting attention. Such a wireless communication system includes, for example, a base station, a plurality of terminals (also referred to as IoT terminals), and a cloud. The IoT terminal acquires an information signal carrying information, and wirelessly transmits a data packet including the information signal to the base station. The base station receives the data packets transmitted from the plurality of IoT terminals, and transmits each of them to the cloud. The cloud stores the information signals included in the received data packets. Accordingly, the user can acquire the information signals acquired by the plurality of IoT terminals by accessing the cloud.

Currently, there has been known a communication system that enables a plurality of terminals to be wirelessly connected to a public network, Internet, and the like via a relay base station (for example, see WO 2013/134259). In the communication system disclosed in WO 2013/134259, each terminal (for example, 402a to 402c in FIG. 4A) is connected to a relay base station (for example, 414a in FIG. 4A) via a local network compliant with IEEE802 as a communication standard of wireless LAN.

When the relay base station receives a data packet transmitted from one terminal, the relay base station sends back an ACK packet to the one terminal to notify the reception of the data packet. In this period, since the relay base station cannot accept a data packet transmitted from another terminal, an ACK packet is not sent back to the other terminal. Therefore, the other terminal repeatedly transmits the data packet until the other terminal receives an ACK packet. Accordingly, a problem arises in that when a power source of the terminal is a battery, a frequency of battery change or charging increases due to the power consumption by repeating the transmission operation.

Therefore, to avoid such a problem, in the communication system disclosed in WO 2013/134259, the following process recommended in IEEE802 standard is performed.

That is, first, mutually different waiting times, what is called back-off values, are set to the respective terminals. Here, when a terminal transmits a data packet, first, the terminal determines whether another terminal other than itself is using a communication channel or not over a period referred to as DIFS. At this time, when the communication channel is determined to be unused, the terminal wirelessly transmits the data packet toward the base station after the elapse of the DIFS and the subsequent waiting time indicated by the back-off value.

In the communication system disclosed in WO 2013/134259, each of the terminals receives a parameter of each terminal relating to the back-off value transmitted from an access point, and the back-off value corresponding to the terminal is obtained from the received parameter.

### SUMMARY OF THE INVENTION

According to the communication system disclosed in WO 2013/134259, while the power consumption can be reduced for each terminal, a time period for the communication to acquire the parameter relating to the back-off value is interposed, thus causing a problem of reduction in transmission efficiency.

When Low Power Wide Area (LPWA) based Sigfox or the like is employed as a public network included in the communication system disclosed in WO 2013/134259, the following problems are caused.

That is, in the communication system, the terminal wirelessly transmits the data packet including the information signal to the relay base station by a communication scheme compliant with IEEE802. The relay base station receiving the data packet wirelessly transmits the data packet to the base station by a communication scheme compliant with Sigfox. At this time, the relay base station transmits the data packet to the base station, for example, taking a time of about 7 seconds per packet by the communication scheme compliant with Sigfox.

Now, in an attempt of cost reduction of the communication system, when a relay base station disabling the reception of the data packet transmitted from one terminal during receiving the data packet transmitted from another terminal and transmitting it to the base station is employed, the one terminal repeatedly retransmits the data packet until an ACK packet is sent back from the relay base station.

Accordingly, a problem arises in that the power consumption due to the retransmission causes the increase in frequency of battery change or charging of the terminal.

Therefore, the present invention has an object to provide a communication system, a wireless terminal, and a wireless communication method enabling a reduction in power consumption of the wireless terminal without reducing a transmission efficiency in transmitting a data packet transmitted from the wireless terminal by a first wireless communication scheme to a base station by a second wireless communication scheme via a relay device.

A communication system according to the present invention includes a plurality of wireless terminals and a relay device. The plurality of wireless terminals each acquire an information signal and transmit a data packet including the acquired information signal by a first wireless communication scheme. The relay device receives the data packet transmitted from the wireless terminal and transmits the received data packet by a second wireless communication scheme different from the first wireless communication scheme. The wireless terminal includes a first wireless communication circuit, a second wireless communication circuit, and a control unit. The first wireless communication circuit performs a wireless communication by the first wireless communication scheme. The second wireless communication circuit performs a wireless communication by the second wireless communication scheme. The control unit determines whether a wireless channel of the second wireless communication scheme is in use or not based on a strength of a reception signal received by the second wireless communication circuit, and causes the first wireless communication circuit to transmit the data packet including the information signal to the relay device when the wireless channel is determined to be unused.

A wireless terminal according to the present invention includes a first wireless communication circuit, a second wireless communication circuit, and a control unit. The first wireless communication circuit performs a wireless communication by a first wireless communication scheme. The second wireless communication circuit performs a wireless communication by a second wireless communication scheme different from the first wireless communication scheme. The control unit determines whether a wireless channel of the second wireless communication scheme is in use or not based on a strength of a reception signal received by the second wireless communication circuit, and causes the first wireless communication circuit to transmit a data packet including an information signal when the wireless channel is determined to be unused.

A wireless communication method according to the present invention is a wireless communication method for transmitting a data packet including an information signal to a relay device by a first wireless communication scheme and transmit the received data packet by a second wireless communication scheme different from the first wireless communication scheme when the relay device receives the data packet. The wireless communication method includes: determining whether a wireless channel of the second wireless communication scheme is unused or not; transmitting the data packet including the information signal to the relay device by the first wireless communication scheme when the wireless channel is determined to be unused; and determining whether the wireless channel of the second wireless communication scheme is in use or not again after waiting for a predetermined waiting time when the wireless channel is determined to be used, and retransmitting the data packet including the information signal to the relay device by the first wireless communication scheme when the wireless channel is determined to be unused.

The communication system according to the present invention includes a relay device that receives a data packet transmitted by a first wireless communication scheme and transmits the received data packet by a second wireless communication scheme, and a plurality of wireless terminals that each determine whether a wireless channel of the second wireless communication scheme is in use or not and transmit the data packet including an information signal to the relay device by the first wireless communication scheme when the wireless channel is determined to be unused.

Therefore, since each of the wireless terminals transmits the data packet to the relay device only when the wireless channel of the second wireless communication scheme is unused, a useless transmission operation can be avoided. Accordingly, the power consumption due to the transmission operation can be reduced while providing a high transmission efficiency compared with a conventional wireless terminal that repeatedly transmits a data packet until an ACK packet is sent back from a relay device.

### BRIEF DESCRIPTION OF THE DRAWINGS

FIG. 1 is a block diagram illustrating a configuration of a communication system 100 according to the present invention;

FIG. 2 is a block diagram illustrating an internal configuration of each of wireless terminals 10a to 10e;

FIG. 3A is a flowchart illustrating a procedure of a terminal communication control executed by a control unit 12 of each of the wireless terminals 10a to 10e;

FIG. 3B is a flowchart illustrating a procedure of the terminal communication control executed by the control unit 12 of each of the wireless terminals 10a to 10e;

FIG. 4 is a drawing illustrating a communication sequence when the wireless terminal 10b transmits a data packet, and subsequently, the wireless terminal 10a transmits a data packet;

FIG. 5 is a flowchart illustrating a procedure of a relay communication control executed by each of relay devices 20 and 30; and

FIG. 6 is a drawing illustrating a communication sequence when an ACK packet does not reach the wireless terminal side.

### DETAILED DESCRIPTION

### Embodiment 1

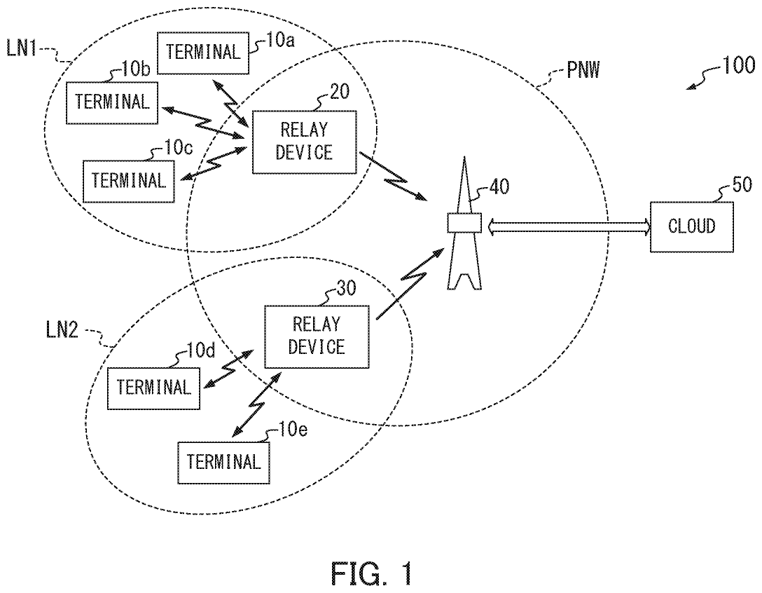

FIG. 1 is a block diagram illustrating a configuration of a communication system 100 as an example of a communication system according to the present invention.

As illustrated in FIG. 1, the communication system 100 includes wireless terminals 10a to 10e, relay devices 20, 30, a base station 40, and a cloud 50.

In the communication system 100 illustrated in FIG. 1, the wireless terminals 10a to 10c and the relay device 20 constitute a first local network that employs, for example, a communication scheme compliant with IEEE802.15.4 k (hereinafter, also referred to as a first wireless communication scheme). In FIG. 1, an area in which the wireless terminals 10a to 10c and the relay device 20 are located is a local communication area LN1 enabling a wireless communication through the first local network. In the communication system 100, the wireless terminals 10d, 10e and the relay device 30 constitute a second local network that employs the first wireless communication scheme. In FIG. 1, an area in which the wireless terminals 10d, 10e and the relay device 30 are located is a local communication area LN2 enabling a wireless communication through the second local network.

Further, in the communication system 100, the relay devices 20, 30 and the base station 40 constitute a public network that employs a Low Power Wide Area (LPWA) based communication scheme compliant with Sigfox (also referred to as a second wireless communication scheme). In FIG. 1, an area in which the relay devices 20, 30 and the base station 40 are located is a public communication area PNW enabling a wireless communication through the public network.

The wireless terminals 10a to 10e each have a wireless communication function employing the first and second wireless communication schemes and an information acquisition function to acquire specific information.

The wireless terminals 10a to 10c in the wireless terminals 10a to 10e acquire specific information (for example, temperature, humidity, illuminance, and vibration) at mutually different positions in the local communication area LN1 illustrated in FIG. 1, and each wirelessly transmit a high frequency signal converted from a sequence of data packets including the acquired information by the first wireless communication scheme to the relay device 20. The wireless terminals 10d and 10e in the wireless terminals 10a to 10e acquire specific information as described above at mutually different positions in the local communication area LN2, and each wirelessly transmit a high frequency signal converted from a sequence of data packets including the acquired information by the first wireless communication scheme to the relay device 30.

The relay device 20 is a wireless relay device having a gateway function. When receiving data packets wirelessly transmitted from the respective wireless terminals 10a to 10c by the first wireless communication scheme, the relay device 20 wirelessly transmits high frequency signals converted from the received data packets by the second wireless communication scheme to the base station 40. When receiving the data packet wirelessly transmitted from one wireless terminal of the wireless terminals 10a to 10c, the relay device 20 wirelessly transmits a high frequency signal converted from an ACK packet indicating a fact of reception of the data packet by the first wireless communication scheme to the one wireless terminal.

As described above, the relay device 20 and each of the wireless terminals 10a to 10c constitute a group (hereinafter referred to as a group 1) that allows them to mutually perform the wireless communication by the first wireless communication scheme (for example, IEEE802.15.4 k) in the local communication area LN1.

The relay device 30 is also a wireless relay device having a gateway function similarly to the relay device 20. When receiving data packets wirelessly transmitted from the respective wireless terminals 10d and 10e by the first wireless communication scheme, the relay device 30 wirelessly transmits high frequency signals converted from the received data packets by the second wireless communication scheme to the base station 40. When receiving the data packet wirelessly transmitted from one wireless terminal of the wireless terminals 10d and 10e, the relay device 30 wirelessly transmits a high frequency signal converted from an ACK packet indicating a fact of reception of the data packet by the first wireless communication scheme to the one wireless terminal.

As described above, the relay device 30 and each of the wireless terminals 10d and 10e constitute a group (hereinafter referred to as a group 2) that allows them to mutually perform the wireless communication by the first wireless communication scheme (for example, IEEE802.15.4 k) in the local communication area LN2.

The base station 40 receives the data packets wirelessly transmitted from the respective relay devices 20 and 30 by the second wireless communication scheme compliant with Sigfox by the second wireless communication scheme, and sequentially stores the received data packets in the cloud 50.

Therefore, according to the communication system 100 illustrated in FIG. 1, accessing to the cloud 50 enables collectively acquiring the information individually acquired by each of the wireless terminals 10a to 10e.

Further, for example, as illustrated in FIG. 1, by locating the relay device 20 in the proximity of a boundary of the public communication area PNW in the public communication area PNW of the public network, the wireless terminals 10a to 10c can be located outside the public communication area PNW.

Therefore, according to the communication system 100 illustrated in FIG. 1, various kinds of specific information can be acquired from the wireless terminals 10a to 10e located in the area not covered by the public network. At least one or all of the wireless terminals 10a to 10e may be located in the public communication area PNW.

Now, as the relay devices 20 and 30, the communication system 100 uses one that disables the reception of the data packet transmitted from one wireless terminal while receiving the data packet transmitted from another wireless terminal and forwarding (transmitting) it to the base station 40.

Therefore, as each of the wireless terminals 10a to 10e, the communication system 100 employs one having a function of reducing the power consumption by waiting for the transmission operation of itself while the relay device (20, 30) forwards (transmits) the data packet to the base station 40.

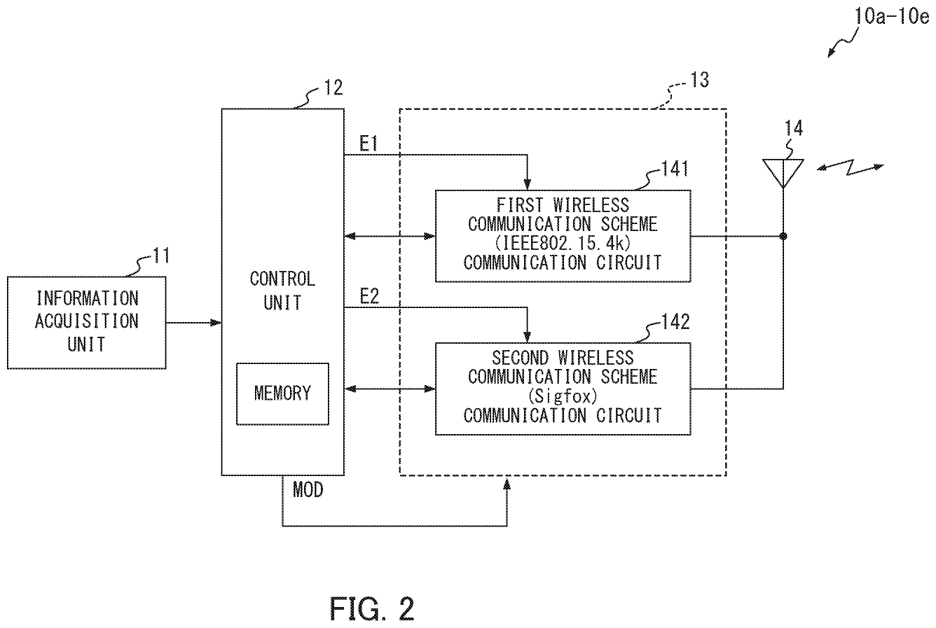

FIG. 2 is a block diagram illustrating an exemplary internal configuration of each of the wireless terminals 10a to 10e.

As illustrated in FIG. 2, each of the wireless terminals 10a to 10e includes an information acquisition unit 11, a control unit 12 and a communication processing unit 13, and an antenna 14, which are operated by a primary battery or a secondary battery (not illustrated).

The information acquisition unit 11 includes, for example, various kinds of sensors (for example, temperature sensor, humidity sensor, illuminance sensor, and vibration sensor), and supplies the control unit 12 with information signals indicating sensor information detected by the sensors. The information acquisition unit 11 can be in a power-saving mode during a waiting period.

The control unit 12 includes a memory that preliminarily stores a program for operating the terminal, its own identification number, and the like, and stores the information signal supplied from the information acquisition unit 11.

The control unit 12 controls the communication processing unit 13 to wirelessly transmit a sequence of data packets in which the information signals are packetized via the antenna 14 in accordance with the program stored in the memory. The control unit 12 supplies the information acquisition unit 11 and the communication processing unit 13 with a power-saving mode signal MOD indicating to turn on the power-saving mode of the communication processing unit 13 while waiting for the transmission operation by the communication processing unit 13 and indicating to turn off the power-saving mode when the transmission operation is started. The control unit 12 itself can be in the power-saving mode while waiting for the next process.

The communication processing unit 13 includes a first wireless communication scheme communication circuit 141 and a second wireless communication scheme communication circuit 142.

The first wireless communication scheme communication circuit 141 is activated only for a predetermined period corresponding to an enable signal E1 supplied from the control unit 12. During the activation, the first wireless communication scheme communication circuit 141 wirelessly transmits the sequence of data packets supplied from the control unit 12 via the antenna 14 by the first wireless communication scheme (for example, IEEE802.15.4 k). The first wireless communication scheme communication circuit 141 receives the ACK packet wirelessly transmitted from the relay device 20 by the first wireless communication scheme via the antenna 14, and supplies a reception signal of it to the control unit 12.

The second wireless communication scheme communication circuit 142 is activated only for a predetermined period corresponding to an enable signal E2 supplied from the control unit 12. During the activation, the second wireless communication scheme communication circuit 142 receives a radio wave in a frequency band compliant with the second wireless communication scheme (for example, Sigfox), and a reception signal indicating a reception level of the radio wave to the control unit 12.

The communication processing unit 13 reduces a power supply voltage supplied to the first wireless communication scheme communication circuit 141 and the second wireless communication scheme communication circuit 142 or stops the supply itself of the power supply voltage when receiving the power-saving mode signal MOD indicating to turn on the power-saving mode. Accordingly, the wireless terminal itself is set to the power-saving mode in which the power consumption decreases.

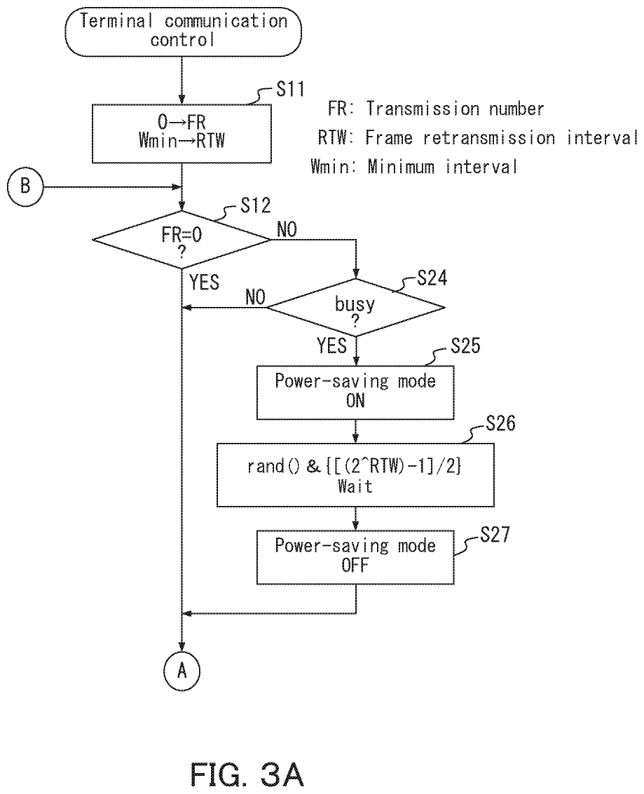

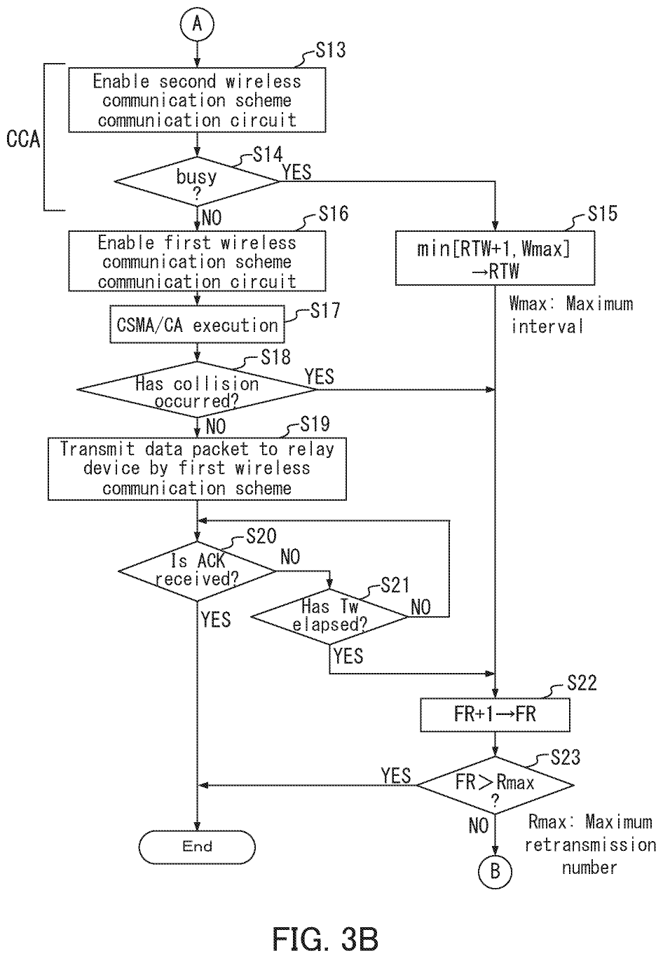

FIG. 3A and FIG. 3B are flowcharts illustrating procedures of the terminal communication control executed by the control unit 12 for transmitting the sequence of data packets obtained by packetizing the information signal acquired by the information acquisition unit 11 to the relay device (20 or 30).

The following describes operations of the control unit 12 along the flowcharts of FIG. 3A and FIG. 3B with the control unit 12 included in the wireless terminal 10a among the wireless terminals 10a to 10e.

First, the control unit 12 sets a transmission number FR indicating “0 (zero)” as an initial value of the number of times of the transmission, and sets a retransmission interval RTW indicating a minimum interval Wmin as an initial value of a retransmission interval when repeatedly retransmitting a frame of the data packet (Step S11).

Next, the control unit 12 determines whether the transmission number FR indicates “0” or not (Step S12).

In Step S12, when the transmission number FR is determined to indicate “0,” the control unit 12 supplies the enable signal E2 instructing the activation to the second wireless communication scheme communication circuit 142 (Step S13). Through Step S13, the second wireless communication scheme communication circuit 142 receives a radio wave in the second wireless communication scheme transmitted from the relay device 20, and supplies a reception signal indicating its reception level to the control unit 12.

Next, the control unit 12 determines whether the relay device 20 is transmitting the data packet by the second wireless communication scheme (for example, Sigfox), that is, a wireless channel is in use (busy) or not based on the strength of the reception signal (Step S14).

That is, through Steps S13 and S14 described above, the control unit 12 executes CCA for determining whether the wireless channel of the second wireless communication scheme (for example, Sigfox) is in use (busy) by the relay device 20 or not.

When the wireless channel of the second wireless communication scheme (for example, Sigfox) is determined to be in use (busy) by the relay device 20 in Step S14, the control unit 20 sets a smaller value of a value obtained by adding “1” to the retransmission interval RTW and a predetermined maximum interval Wmax as a new retransmission interval RTW (Step S15).

Meanwhile, when the wireless channel of the second wireless communication scheme (for example, Sigfox) is determined to be unused (busy) by the relay device 20 in Step S14, the control unit 12 supplies the enable signal E1 instructing the activation to the first wireless communication scheme communication circuit 141 (Step S16). Through Step S16, the first wireless communication scheme communication circuit 141 is activated.

Next, the control unit 12 executes Carrier Sense Multiple Access/Collision Avoidance (CSMA/CA) in the first wireless communication scheme communication circuit 141 (Step S17). The control unit 12 determines whether a frame collision with the other wireless terminal group (10b and 10c) has occurred or not based on the execution result of CSMA/CA (Step S18).

When the frame collision is determined not to have occurred in Step S18, the control unit 12 supplies the first wireless communication scheme communication circuit 141 with a sequence of data packets in which the identification number and the information signal stored in the memory are sequentially packetized every predetermined bit length. Accordingly, the control unit 12 causes the first wireless communication scheme communication circuit 141 to wirelessly transmit the sequence of data packets to the relay device 20 by the first wireless communication scheme (Step S19). When receiving the sequence of data packets, the relay device 20 wirelessly transmits an ACK packet notifying a fact of reception of the data packet to the wireless terminal 10a.

After executing Step S19, the control unit 12 determines whether the first wireless communication scheme communication circuit 141 has received the ACK packet transmitted from the relay device 20 or not (Step S20). When the ACK packet is determined not to have been received in Step S20, the control unit 12 determines whether a predetermined time Tw has elapsed after the execution of Step S19 or not (Step S21). When the predetermined time Tw is determined not to have elapsed in Step S21, the control unit 12 returns to the execution of Step S20, and executes the above-described operation again.

When the predetermined time Tw is determined to have elapsed in Step S21, or when the frame collision is determined to have occurred in Step S18, or after the execution of Step S15, the control unit 12 sets a value obtained by adding “1” to the current transmission number FR to a new transmission number FR (Step S22).

Next, the control unit 12 determines whether the transmission number FR is larger than a predetermined maximum retransmission number Rmax or not (Step S23). When the transmission number FR is determined to be equal to or less than the maximum retransmission number Rmax in Step S23, the control unit 12 returns to the execution of Step S12, and executes the above-described operation again.

Here, when the transmission number FR is determined to be larger than “0” in Step S12, the control unit 12 determines whether the relay device 20 is transmitting the data packet by the second wireless communication scheme (for example, Sigfox), that is, the wireless channel is in use (busy) or not based on the strength of the reception signal output from the second wireless communication scheme communication circuit 142 (Step S24).

When the wireless channel of the second wireless communication scheme (for example, Sigfox) is determined to be in use (busy) by the relay device 20 in Step S24, the control unit 12 supplies the power-saving mode signal MOD to turn on the power-saving mode to the communication processing unit 13 (Step S25). Accordingly, an amount of the power consumption of the communication processing unit 13 is reduced, and in association with this, an amount of the power consumption of the wireless terminal 10a itself is also reduced.

Next, the control unit 12 waits for a waiting time indicating a random time period expressed by a formula below (Step S26).

waiting time=rand( )&{[(2\hat{ }RTW)−1]/2}

rand( ): random number function

&: a bit AND operator

After the elapse of the waiting time, the control unit 12 supplies the power-saving mode signal MOD to turn off the power-saving mode to the communication processing unit 13 (Step S27).

Then, after the execution of Step S27, or when the wireless channel of the second wireless communication scheme (for example, Sigfox) is determined to be unused (busy) by the relay device 20 in Step S24, the control unit 12 continues to execute a series of processes of Steps S13 to S23 described above. That is, the control unit 12 retransmits the data packet by the series of processes of Steps S25 to S27 and S13 to S23.

In this period, when the ACK packet is determined to have been received in Step S20, the control unit 12 determines that the transmission is normally completed, stores history information indicating the success of the transmission process of the data packet including the retransmission in the memory, and then, ends the terminal communication control illustrated in FIG. 3A and FIG. 3B.

When the transmission number FR is determined to be larger than the maximum retransmission number Rmax in Step S23, the control unit 12 determines that the transmission process of the data packet including the retransmission has failed, stores history information indicating the transmission failure in the memory, and then, ends the terminal communication control illustrated in FIG. 3A and FIG. 3B.

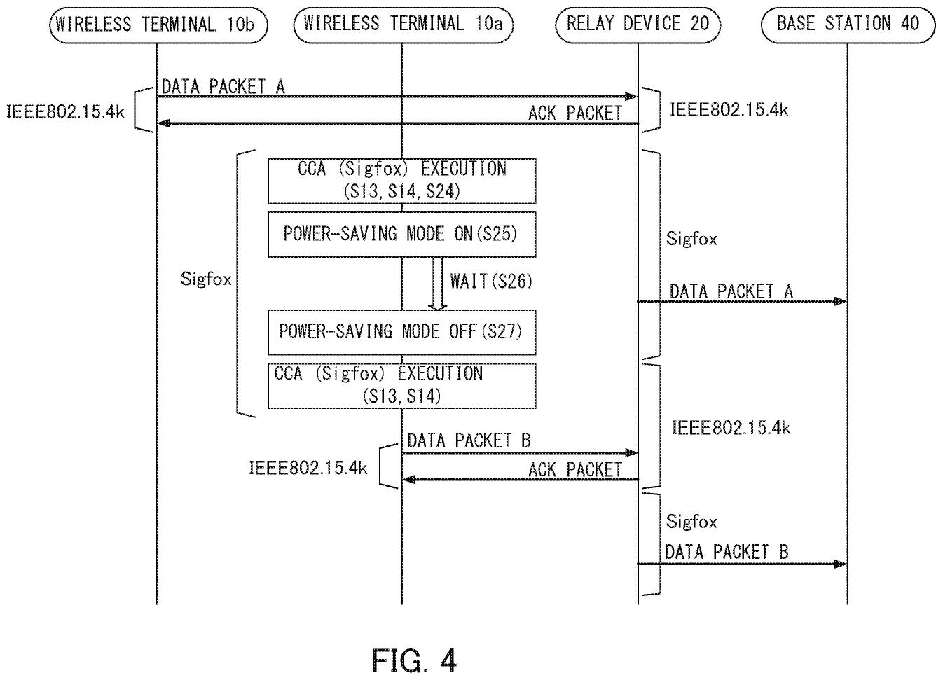

The following describes a communication operation between the wireless terminals, the relay device, and the base station in the terminal communication control illustrated in FIG. 3A and FIG. 3B with an example illustrated in FIG. 4.

FIG. 4 is a drawing illustrating a communication sequence between the wireless terminals 10a, 10b, the relay device 20, and the base station 40 when the wireless terminal 10b transmits a data packet, and subsequently, the wireless terminal 10a transmits a data packet.

As illustrated in FIG. 4, first, the wireless terminal 10b wirelessly transmits a data packet A to the relay device 20 by the first wireless communication scheme (IEEE802.15.4 k). Upon receiving the data packet A, the relay device 20 sends back an ACK packet to the wireless terminal 10b, and subsequently, wirelessly transmits the data packet A to the base station 40 by the second wireless communication scheme (Sigfox). Here, the wireless terminal 10a executes CCA by the second wireless communication scheme (S13, S14, S24). At this time, since the wireless channel of the second wireless communication scheme is in use for the wireless transmission of the data packet A by the relay device 20, the wireless terminal 10a transitions to the power-saving mode (S25). Then, after waiting for the waiting time indicated by rand( )&{[(2\hat{ }RTW)−1]/2} (S26), the wireless terminal 10a releases the power-saving mode (S27) and executes the CCA by the second wireless communication scheme again (S13, S14). Here, when the transmission operation of the data packet A in the second wireless communication scheme by the relay device 20 ends, the wireless channel of the second wireless communication scheme becomes to be unused. Therefore, the wireless terminal 10a wirelessly transmits a data packet B acquired by itself to the relay device 20 by the first wireless communication scheme (IEEE802.15.4 k) (S19). Upon receiving the data packet B, the relay device 20 sends back an ACK packet to the wireless terminal 10a, and then, wirelessly transmits the data packet B to the base station 40 by the second wireless communication scheme (Sigfox).

Thus, the wireless terminal 10a executes the CCA by the second wireless communication scheme used in the transmission from the relay device 20 to the base station 40 before transmitting the data packet B (information signal) to the relay device 20. Accordingly, the wireless terminal 10a determines whether the wireless channel of the second wireless communication scheme is in use by the relay device 20 or not, and transmits the data packet B that is acquired by itself and includes the information signal to the relay device 20 only when the wireless channel of the second wireless communication scheme is determined to be unused.

Accordingly, since the wireless terminal 10a transmits the data packet only when the relay device 20 is ready for receiving the data packet, the wireless terminal 10a can avoid a useless transmission operation. Further, when the wireless channel of the second wireless communication scheme is in use by the relay device 20, the wireless terminal 10a transitions to the power-saving mode for the predetermined waiting time before retransmitting the data packet with the CCA as a starting point.

Accordingly, with the wireless terminal 10a, the power consumption associated with the transmission operation can be reduce while providing a high transmission efficiency compared with the conventional wireless terminal that repeatedly transmits the data packet until the ACK packet is sent back from the relay device 20. The operation of the wireless terminal 10a illustrated in FIG. 3A, FIG. 3B, and FIG. 4 and the effect of reducing the power consumption by the wireless terminal 10a are similarly provided also for the other wireless terminals 10b to 10e.

The wireless terminals 10a to 10e determine that the wireless channel is in use (busy) by the relay device (20, 30) for the CCA, and perform the retransmission process (S25 to S27, S13 to S23) of retransmitting the data packet after waiting for the waiting time indicated as below. At this time, the retransmission interval RTW increases by “1” (S15) every time when the CCA is executed (S13, S14).

rand( )&{[(2\hat{ }RTW)−1]/2}

Accordingly, for example, when the retransmission interval RTW is “4,” [(2\hat{ }4)−1]/2 becomes “7” by rounding down to the nearest whole number, and the waiting time obtained from a bit array of rand( ) becomes 0 to 7 seconds. When the retransmission interval RTW is “5,” [(2\hat{ }5)−1]/2 becomes “15” by rounding down to the nearest whole number, and the waiting time obtained from the bit array of rand( ) becomes 0 to 15 seconds. When the retransmission interval RTW is “6,” [(2\hat{ }6)−1]/2 becomes “31” by rounding down to the nearest whole number, and the waiting time obtained from the bit array of rand( ) becomes 0 to 31 seconds.

Thus, the waiting time is lengthened every time when the CCA is performed, thereby enabling the transmission operations of the wireless terminals to be waited while the relay devices (20, 30) sequentially receive the data packets from each of the plurality of wireless terminals and transmit the data packets to the base station 40. Further, the wireless terminals can be set to the power-saving mode during the waiting time.

For rand( ) as a parameter to determine the waiting time for each of the wireless terminals 10a to 10e, by giving a “seed” of random number (hereinafter, referred to as a random seed) using srand( ) at the turning on the power or the activation, the generation pattern of the random number may be changed. For example, when an individual address is given to each of the wireless terminals 10a to 10e, this address is used as a random seed of srandO.

Thus, rand( ) has a different value for each of the wireless terminals 10a to 10e. Accordingly, since the waiting time before the retransmission of the data packet is started for each of the wireless terminals becomes a random period having the address as the random seed, the transmission timings are less likely to mutually collide between the wireless terminals, thereby attempting to improve the throughput.

As the random seed, a combination of the address assigned to each of the wireless terminals 10a to 10e and, for example, a group ID assigned to each of the group 1 (wireless terminals 10a to 10c and relay device 20) and the group 2 (wireless terminals 10d, 10e, and relay device 30) may be employed.

For example, when the random seed is 32 bits, a random seed indicates as follows is set.

0th to seventh bits: address of each wireless terminal

eighth to fifteenth bits: group ID

sixteenth to 31st bits: arbitrary value

That is, for example, when the address of the wireless terminal is “0×00,” the group ID is “0×01,” and the arbitrary value is “0×1234,” a 32-bit random seed of “0×12340100” is set.

This allows surely making transmission start timings of the respective wireless terminals different compared with the case where the random seed is set with the address alone.

For example, when the random seed is set with the address alone, the address assigned in the group 1 to which the wireless terminals 10a to 10c belong is the same as the address assigned in the group 2 to which the wireless terminals 10d and 10e belong in some cases. Therefore, in a state where a radio wave reaches between the groups, since the random seed obtained by the wireless terminal belonging to the group 1 is the same as the random seed obtained by the wireless terminal belonging to the group 2 in some cases, the transmission start timings possibly match one another. Meanwhile, as described above, by setting the random seed with the combination of the address and the group ID, even when the address of the wireless terminal belonging to the group 1 is the same as the address of the wireless terminal belonging to the group 2, the group IDs are different, thus allowing the random seeds of both wireless terminals to be different.

Accordingly, the transmission start timings of the wireless terminals can be mutually different with more certainty, thereby attempting to improve the throughput.

The relay devices 20 and 30 both transmit the ACK packets to the wireless terminals as the transmission sources when receiving the data packets transmitted from the wireless terminals (10a to 10e). However, the transmitted ACK packet does not reach the wireless terminal side because of a sudden noise or the like in some cases.

In this case, while the relay device receives the data packet transmitted from the wireless terminal and completes forwarding it to the base station 40, the wireless terminal side cannot receive the ACK packet, and therefore, the wireless terminal side performs an invalid retransmission process (S25 to S27, S13 to S23) of retransmitting the data packet.

Therefore, to avoid the invalid retransmission process in the wireless terminal side, a countermeasure below may be taken in the communication system 100.

That is, each of the wireless terminals 10a to 10e generates a sequence of data packets including the group ID representing the group to which the wireless terminal itself belongs and a sequence number together the information signal in packetizing the information signal in Step S19. The sequence number represents an arrangement order of the data packets in the sequence of data packets, the newer the data packet is in time, the more increased the sequence number is. Since the sequence numbers assigned to the respective data packets are not changed, the sequence number is fixed regardless of the number of retransmissions when the data packet is retransmitted.

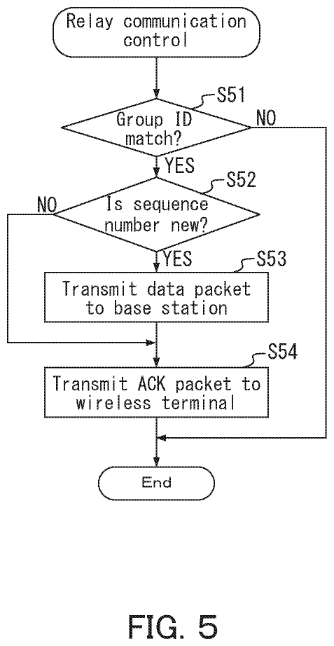

Each of the relay devices 20 and 30 executes a communication process illustrated in FIG. 5 every time when receiving the data packet.

In FIG. 5, the relay device 20 (30) determines whether the group ID included in the received data packet matches the group ID of the relay device 20 (30) itself or not (Step S51). In Step S51, when the relay device 20 (30) determines that the group ID matches the group ID of itself, the relay device 20 (30) determines whether the sequence number included in the received data packet is new or not (Step S52). That is, in Step S52, when the sequence number is larger than the largest one in the sequence numbers included in the data packets received so far, the relay device 20 (30) determines that the data packet received this time is new. Meanwhile, when the sequence number included in the data packet received this time is smaller than the largest one in the sequence numbers acquired so far, the relay device 20 (30) determines that the data packet received this time is the retransmitted data packet.

When the sequence number is determined to be new in Step S52, the relay device 20 (30) transmits the received sequence of data packets to the base station 40 by the second wireless communication scheme (Step S53).

After executing Step S53, or when the sequence number is determined not to be new, that is, the data packet received this time is determined to be retransmitted one in Step S52, the relay device 20 (30) transmits the ACK packet to the wireless terminal as the transmission source by the second wireless communication scheme (Step S54).

After executing Step S54, or when the group ID is determined not to match the group ID of itself in Step S51, the relay device 20 (30) ends the communication process illustrated in FIG. 5.

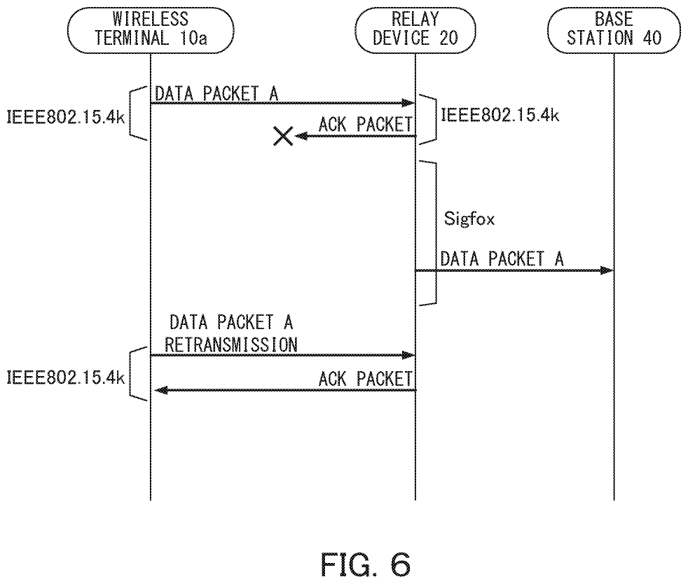

The following describes a communication operation between the wireless terminals, the relay device, and the base station in the relay communication control illustrated in FIG. 5 with an example illustrated in FIG. 6.

FIG. 6 is a drawing illustrating a communication sequence between the wireless terminal 10a, the relay device 20, and the base station 40 when the ACK packet does not reach the wireless terminal 10a.

First, the wireless terminal 10a transmits a data packet A including the group ID of itself and the sequence number to the relay device 20 by the first wireless communication scheme (IEEE802.15.4 k) together with the information signal acquired by itself.

Upon receiving the data packet A, the relay device 20 determines whether the group ID included in the received data packet A matches the group ID of itself or not (S51), and discards the received data packet A when both do not match one another.

When the group ID included in the received data packet A is determined to match the group ID of itself, the relay device 20 determines whether the sequence number included in the data packet A is new or not (S52). When the sequence number is new, that is, when the data packet A is not the retransmitted data packet, the relay device 20 transmits the data packet A to the base station 40 by the second wireless communication scheme (Sigfox), and transmits the ACK packet to the wireless terminal 10a by the first wireless communication scheme.

In the example illustrated in FIG. 6, assume that while the ACK packet is transmitted from the relay device 20 at this time, the ACK packet does not reach the wireless terminal 10a due to an influence of a sudden spatial noise or the like.

Accordingly, since the ACK packet cannot be received even after the elapse of the predetermined time Tw from the transmission of the data packet A, the wireless terminal 10a retransmits the data packet A to the relay device 20 by the first wireless communication scheme as illustrated in FIG. 6. Since the sequence number included in the data packet A is the same as the previous one, the relay device 20 determines the data packet A as the retransmitted packet, and does not transmit the data packet A to the base station 40 because it has been already transmitted to the base station 40. However, at this time, the ACK packet is transmitted to the wireless terminal 10a by the first wireless communication scheme as illustrated in FIG. 6. The reason for transmitting the ACK packet is that the ACK packet is determined not to reach the wireless terminal 10a for some reason when the relay device 20 transmits the ACK packet to the wireless terminal 10a at first. When the ACK packet does not reach the wireless terminal 10a, the wireless terminal 10a repeats the retransmission. Therefore, the relay device 20 sends back the ACK packet also when receiving the already received data packet A again, thereby causing the wireless terminal 10a to end the retransmission operation, thus reducing the power consumption of the wireless terminal 10a.

As described above, the relay devices 20 and 30 perform the relay communication control illustrated in FIG. 5, thereby determining whether the received data packet is a data packet retransmitted from any one wireless terminal of the wireless terminals 10a to 10e or not with the group ID and the sequence number included in the received data packet at first. Then, when the received data packet is the retransmitted data packet, the relay devices 20 and 30 transmit the ACK packet again to the one wireless terminal assuming a case where the ACK packet does not reach the one wireless terminal, thus causing the wireless terminal to end the retransmission operation to reduce the power consumption.

In the communication system 100 of the above-described embodiments, the wireless terminals 10a to 10c and the relay device 20 constitute the first group 1, and the wireless terminals 10d, 10e and the relay device 30 constitute the second group 2. However, the number of the groups including the relay device and the wireless terminal group is not limited to two, and the number of the wireless terminals connected to one relay device is also not limited to two or three. That is, it is only necessary that the communication system 100 includes m (m is an integer of 1 or more) relay devices to each of which a plurality of wireless terminals are connected.

In the communication system 100, IEEE802.15.4 k is employed as the first wireless communication scheme used for the wireless communication between the wireless terminal and the relay device, and Sigfox is employed as the second wireless communication scheme used for the wireless communication between the relay device and the base station. However, other wireless communication schemes may be employed for the respective first and second wireless communication schemes.

For example, as the first wireless communication scheme between the wireless terminal and the relay device, ZigBee compliant with IEEE802.15.4 standard using a 2.4 GHz band, WiFi compliant with the standard of IEEE802.11 series using a 2.4 GHz band or a 5 GHz band, and the like may be employed.

As the second wireless communication scheme between the relay device and the base station, LoRaWAN, Wi-Fi HaLow, Wi-SUN, ZETA, and the like, which are based on Low Power Wide Area (LPWA), may be employed.

Basically, it is only necessary that the communication system 100 includes a plurality of wireless terminals that each acquire an information signal and transmit a data packet including the acquired information signal by a first wireless communication scheme, and a relay device that receives the data packet transmitted from the wireless terminal and transmits the received data packet by a second wireless communication scheme different from the first wireless communication scheme.

It is only necessary that each of the wireless terminals includes a first wireless communication circuit (141) that performs a wireless communication by the first wireless communication scheme, a second wireless communication circuit (142) that performs a wireless communication by the second wireless communication scheme, and a control unit (12) below.

The control unit (12) determines whether a wireless channel of the second wireless communication scheme is in use or not based on a strength of a reception signal received by the second wireless communication circuit (S14, S24), and causes the first wireless communication circuit to transmit the data packet including the information signal to the relay device when the wireless channel is determined to be unused (S19).

It is understood that the foregoing description and accompanying drawings set forth the preferred embodiments of the present invention at the present time. Various modifications, additions and alternative designs will, of course, become apparent to those skilled in the art in light of the foregoing teachings without departing from the spirit and scope of the disclosed invention. Thus, it should be appreciated that the present invention is not limited to the disclosed Examples but may be practiced within the full scope of the appended claims.

What is claimed is:

1. A communication system comprising:
a plurality of wireless terminals that each acquire an information signal and transmit a data packet including the acquired information signal by a first wireless communication scheme; and
a relay device that receives the data packet transmitted from the wireless terminal and transmits the received data packet by a second wireless communication scheme different from the first wireless communication scheme, wherein
the wireless terminal includes:
a first wireless communication circuit that performs a wireless communication by the first wireless communication scheme;
a second wireless communication circuit that performs a wireless communication by the second wireless communication scheme; and
a control unit that determines whether a wireless channel of the second wireless communication scheme is in use or not based on a strength of a reception signal received by the second wireless communication circuit, and causes the first wireless communication circuit to transmit the data packet including the information signal to the relay device when the wireless channel is determined to be unused.

2. The communication system according to claim 1, wherein
the control unit determines whether the wireless channel of the second wireless communication scheme is in use or not based on the strength of the reception signal received by the second wireless communication circuit after waiting for a waiting time set for each of the wireless terminals when the wireless channel is determined to be in use, and the control unit causes the first wireless communication circuit to retransmit the data packet including the information signal to the relay device when the wireless channel is determined to be unused.

3. The communication system according to claim 2, wherein
the control unit sets the wireless terminal itself to a power-saving mode during the waiting time.

4. The communication system according to claim 2, wherein
the waiting time is a time period based on a retransmission interval increased every time when the retransmission is performed and a random number obtained by a random number function with a random seed including an address assigned to each of the plurality of wireless terminals.

5. The communication system according to claim 4, wherein
the waiting time is expressed as below
the random number function &{[(2\hat{ } the retransmission interval)−1]/2}&: a bit AND operator.

6. The communication system according to claim 1, wherein
the relay device transmits an ACK packet to the wireless terminal as a transmission source by the first wireless communication scheme when the relay device receives the data packet transmitted from the wireless terminal.

7. The communication system according to claim 1, wherein
the data packet includes a sequence number indicating an arrangement order of the data packet in a sequence, and
the relay device determines whether the data packet received by the relay device itself is a data packet retransmitted from the wireless terminal or not based on the sequence number included in the data packet, and the relay device does not transmit the data packet received by the relay device itself when the data packet is determined as the retransmitted data packet.

8. The communication system according to claim 1, wherein
the second wireless communication scheme is reduced in power consumption and is a wide area wireless communication scheme based on Low Power Wide Area-network (LPWA) compared with the first wireless communication scheme.

9. A wireless terminal comprising:
a first wireless communication circuit that performs a wireless communication by a first wireless communication scheme;
a second wireless communication circuit that performs a wireless communication by a second wireless communication scheme different from the first wireless communication scheme; and
a control unit that determines whether a wireless channel of the second wireless communication scheme is in use or not based on a strength of a reception signal received by the second wireless communication circuit, and causes the first wireless communication circuit to transmit a data packet including an information signal when the wireless channel is determined to be unused.

10. A wireless communication method for transmitting a data packet including an information signal to a relay device by a first wireless communication scheme and transmit the received data packet by a second wireless communication scheme different from the first wireless communication scheme when the relay device receives the data packet, the wireless communication method comprising:
determining whether a wireless channel of the second wireless communication scheme is unused or not;
transmitting the data packet including the information signal to the relay device by the first wireless communication scheme when the wireless channel is determined to be unused; and
determining whether the wireless channel of the second wireless communication scheme is in use or not again after waiting for a predetermined waiting time when the wireless channel is determined to be used, and retransmitting the data packet including the information signal to the relay device by the first wireless communication scheme when the wireless channel is determined to be unused.
